(19) United States
(12) Patent Application Publication
(10) Pub. No.: US 2011/0117968 A1
(43) Pub. Date: May 19, 2011

(54) INPUT DEVICE FOR A USER INTERFACE

(75) Inventor: Marko Eromaki, Tampere (FI)

(73) Assignee: NOKIA CORPORATION, Espoo (FI)

(21) Appl. No.: 12/617,974

(22) Filed: Nov. 13, 2009

(51) Int. Cl. H04M 1/00; G06F 3/041

(52) U.S. Cl. 455/566; 345/173; 455/575.3

(57) ABSTRACT

An apparatus, which includes a body part, an input component attached to the body part, graphics on the input component, the graphics being invisible in daylight conditions and visible when exposed to a certain type of illumination, and a source of light configured to provide illumination of the certain type and to selectively illuminate the transparent input component.

### TECHNICAL FIELD

The present invention generally relates to user interfaces and input devices and particularly but not exclusively to input devices in handheld devices.

### BACKGROUND ART

Electronic handheld devices, such as mobile phones, personal digital assistants (PDA), handheld computers, laptops, media players, and cameras, typically comprise a user interface for interacting with the user. The user interface typically includes one or more output devices, such as displays and loudspeakers, and one or more input devices, such as keyboards and track pads.

For example translucent dual sided track pads have been provided as one type of an input device for handheld devices. Such translucent component may include symbols or markings implemented by means of a liquid crystal (polarizing) film.

### SUMMARY

According to a first example aspect of the invention there is provided an apparatus comprising:

a body part,
an input component coupled with the body part,
the input component having graphics, the graphics being invisible in daylight conditions and visible when exposed to a certain type of illumination, and
a source of light configured to provide illumination of the certain type and to selectively illuminate the transparent input component.

According to a second example aspect of the invention there is provided an input component comprising:

a touch sensitive layer,
a cover layer, and
graphics, the graphics being invisible in daylight conditions and visible when exposed to a certain type of illumination.

According to a third example aspect of the invention there is provided a method comprising:

providing a user interface, the user interface comprising an input component and the input component comprising graphics that are invisible in daylight conditions and visible when exposed to a certain type of illumination; and
selectively illuminating the input component with illumination of the certain type.

According to a fourth example aspect of the invention there is provided a computer program comprising computer executable program code which, when executed by at least one processor of an apparatus, the apparatus comprising a body part, an input component coupled with the body part, and graphics on the input component, the graphics being invisible in daylight conditions and visible when exposed to a certain type of illumination, causes the apparatus to perform:

providing through the input component a user interface configured to interact with a user of the apparatus; and
processing electrical feedback from the input component.

According to yet another example aspect of the invention there is provided a computer readable medium or memory medium embodying the computer program of the fourth example aspect.

Different non-binding example aspects of the present invention have been illustrated in the foregoing.

### BRIEF DESCRIPTION OF THE DRAWINGS

The invention will be described, by way of example only, with reference to the accompanying drawings, in which:

FIG. 1A illustrates an example structure of an input component according to an embodiment of the invention;

FIG. 1B shows a side cross sectional view of the input component of an example embodiment shown of FIG. 1A;

FIGS. 2A-2B show an apparatus according to an example embodiment of the invention;

FIGS. 3A-3B show an apparatus according to an example embodiment of the invention;

FIGS. 4A-4B show an apparatus according to an example embodiment of the invention;

FIGS. 5A-5B show an apparatus according to an example embodiment of the invention;

FIGS. 6A-6B show an apparatus according to an example embodiment of the invention;

FIGS. 6C-6D show an apparatus according to an example embodiment of the invention;

FIG. 7A shows an example illumination arrangement in the apparatus of FIGS. 2A and 2B

FIG. 7B shows an example illumination arrangement in the apparatus of FIGS. 3A and 3B;

FIGS. 8A-8C illustrate some further example illumination arrangements;

FIGS. 9A-9B illustrate yet another example embodiment of the invention;

FIG. 10 shows a flow chart of an example method; and

FIG. 11 shows a block diagram of an example apparatus.

### DETAILED DESCRIPTION

In the following, various example embodiments are discussed. It needs to be observed that a detail discussed in connection with one of the embodiments is not limited to that particular embodiment. I.e. details disclosed in connection with one of the embodiments can be applied to other embodiments as well.

In an example embodiment visibility of user interface elements (graphics, e.g. symbols, characters) is changed depending on the usage scenario. In this way one can create a user interface component, which is visible and accessible in certain situations, e.g. when the user interface is in use, and hidden in certain situation, e.g. when the user interface is not in use. The user interface component can be integrated e.g. in a cover part or in a track pad.

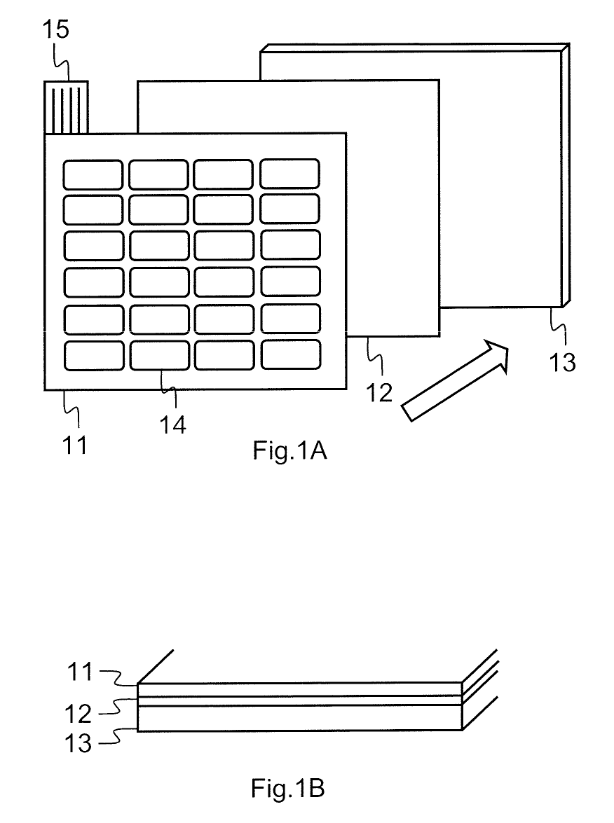

FIG. 1A illustrates an example structure of an input component according to an example embodiment of the invention.

FIG. 1A shows parts of the example input component. The parts are attached to each other to form the input component. The parts comprise a touch sensitive layer 11, an adhesive film 12, a cover layer 13, and symbols 14. Electrical signals can be brought to the touch sensitive layer through wiring 15. The touch sensitive layer 11 may be e.g. a touch sensitive film. The cover layer 13 may be for example plastic and particularly transparent plastic in some embodiments. Alternatively some other material may be used, e.g. glass may be used. The touch sensitive layer 11 and the cover layer 13 may be attached to each other by the adhesive film 12. Instead of using the adhesive film 12, the touch sensitive layer 11 and the cover layer 13 may be attached to each other in some other way, e.g. by gluing or by adhesive included in the cover layer 13 or the touch sensitive layer 11. I.e. the adhesive layer is not a mandatory part. Further, the touch sensitive layer 11 and the adhesive film 12 are transparent in some embodiments. I.e. the input component may be fully transparent.

In an example embodiment, the symbols 14 are produced with transparent or invisible ink, which is invisible in daylight conditions and becomes visible when illuminated with certain type of light (e.g. light having a specific wavelength). An example of such transparent or invisible ink is UV (ultraviolet) ink, which becomes visible when illuminated with UV light. The symbols may be printed or otherwise produced on any one of the layers of the input device. The symbols may be e.g. printed with ink jet or silk screened directly on top of the touch sensitive layer 11. The symbols may be placed below the touch sensitive layer 11 as well. In an alternative example embodiment, the symbols are printed on an additional film included in the component, but including yet another layer only for this purpose is not mandatory. Printing the symbols on the touch sensitive layer 11 may be integrated into manufacturing process of the touch sensitive layer (or into manufacturing process of one of the other layers), which may contribute to minimizing the additional cost caused by the symbols. Different symbol sets may be used for example to provide different language packs. Additionally different colors may be used in the symbols (one symbol set can include multiple colors or different sets may be printed with different colors). The symbols 14 may include any kind of symbols or graphics, such as letters, numbers, drawing symbols, some other characters etc.

In an example embodiment, the cover layer 13 is used as a light guide for guiding illumination to the symbols 14 on the input component and thereby making them visible. The light coming into the input component may be configured to reflect inside the cover layer and thereby make the invisible symbols visible. The input component may be illuminated from below the component or from top of the component or from the side of the component.

In an example embodiment, the touch sensitive layer 11 is used to detect, which symbols are pressed by a user, i.e. to receive input from the user. In this way a functional, selectively hidden keyboard may be constructed.

FIG. 1B shows a side cross sectional view of the input component of an example embodiment shown of FIG. 1A. The cross sectional view shows the cover layer 13, the adhesive film 12, and the touch sensitive layer 11 on top of each other.

In various embodiments, the input component (e.g. the input component of FIGS. 1A and 1B) is coupled with or attached to an electrical apparatus for interacting with a user of the apparatus. The apparatus may be for example a mobile phone, a pda, a handheld computer, a laptop, a media player, or a camera. The input component may be movably attached to a body of the apparatus. The input component may be for example hinged to the body of the apparatus, whereby the input component may be folded from one position to another, e.g. from an open to a closed position and vice versa. Alternatively, a sliding connection may be used between the input component and the body part. There may be for example a linear guide guiding the movement of the input component. The input component may be movable on its own or it may be included in a larger movable part of the apparatus, whereby the input component is moved if said movable part is moved.

In an embodiment, when the input component (e.g. the input component of FIGS. 1A and 1B) is in a closed position, the touch sensitive layer 11 of the input component faces the body part of the apparatus to which the input component is attached, and when the input component is in an open position, the touch sensitive layer 11 of the input component is exposed to the user of a apparatus for providing input. In closed position the input component may be placed on top of a display of the apparatus, for example. In this way the cover layer 13 of the input component can be used to protect the display (or some other part of the apparatus) against mechanical stress and scratching, while keeping the display fully visible at the same time. The input component does not necessarily cover the display or the apparatus in full, but may equally cover only part of the display or the apparatus.

The source of light used for illuminating the input component and making the symbols or graphics on the input component visible may be placed in the body part of the electrical apparatus.

Various example implementations are discussed in more detail below. One should appreciate that only simplified structures are shown and that any one of the shown apparatuses typically includes also other components.

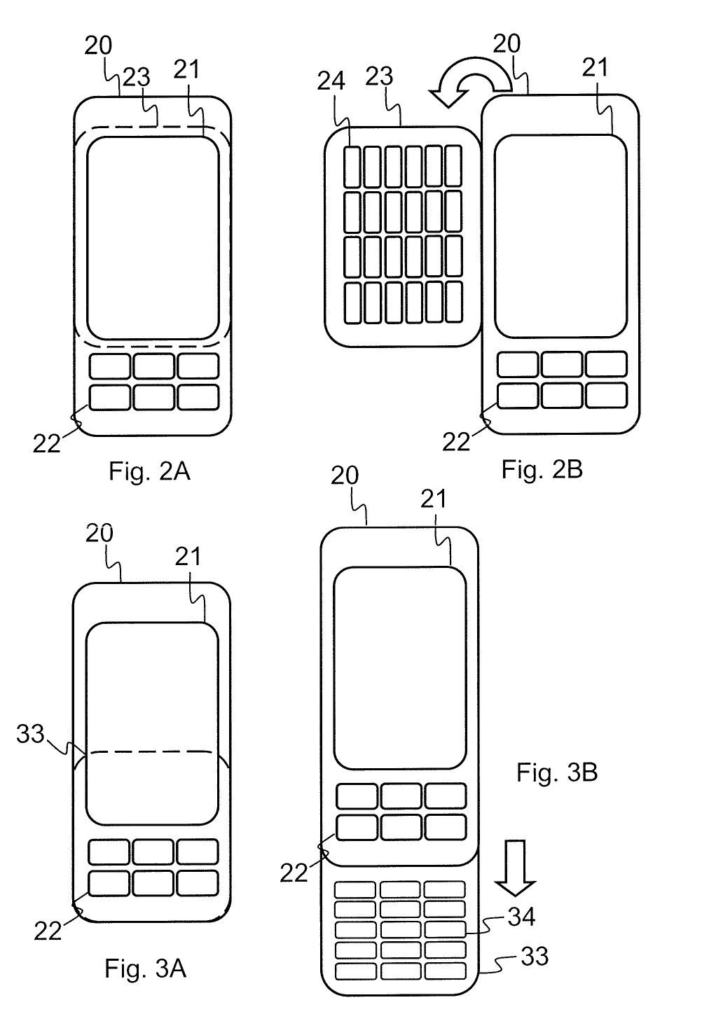

FIG. 2A shows an apparatus according to an example embodiment of the invention. The apparatus comprises a body part 20, a display 21, keys 22 and a transparent input component 23. The transparent input component 23 is attached to the body part 20 with a hinge (not shown). In FIG. 2A, the transparent input component 23 is shown in a closed position on top of the display 21. FIG. 2B shows the apparatus of FIG. 2A with the transparent input component 23 folded into an open position. In FIG. 2B a transparent keyboard 24 on the transparent input component 23 has been made visible.

FIG. 3A shows an apparatus according to an example embodiment of the invention. The apparatus is similar to the one of FIG. 2A, except that now the apparatus comprises a transparent input component 33 instead of the transparent input component 23 of FIG. 2A. The transparent input component 33 is slidably connected to the body part 20. The transparent input component 33 is shown in a closed position in FIG. 3A. The transparent input component 33 may be attached on top of or below the body part 20 or it may be placed in a recess (not shown) inside the body part 20. FIG. 3B shows the apparatus of FIG. 3A with the transparent input component 33 slid into an open position. In FIG. 3B a transparent keyboard 34 on the transparent input component 33 has been made visible. FIGS. 3A and 3B show a transparent input component that is smaller than the body part 20. This is however only one example. Clearly the transparent input component could cover the body part in full, for example.

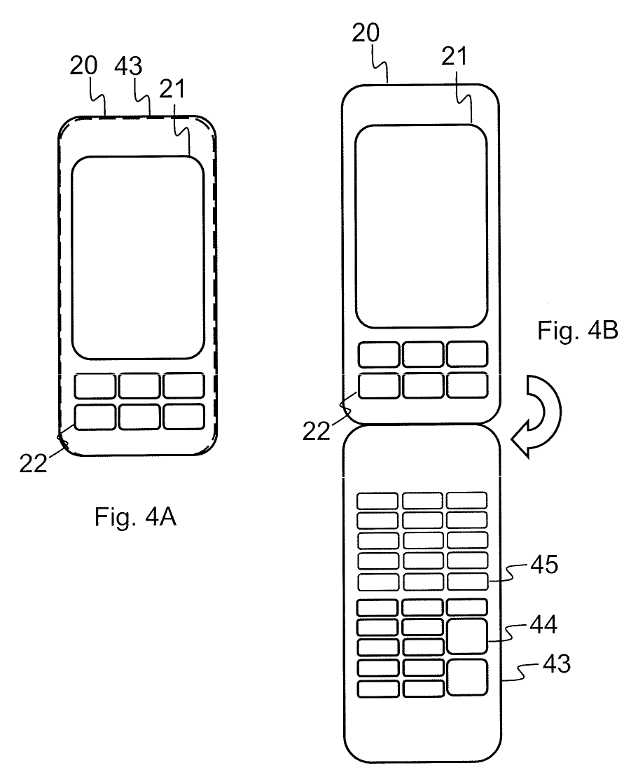

FIG. 4A shows an apparatus according to an example embodiment of the invention. The apparatus is similar to the one of FIG. 2A, except that now the apparatus comprises a transparent input component 43 instead of the transparent input component 23 of FIG. 2A. The transparent input component 43 is hinged to the body part from a different side compared to the transparent input component 23 of FIG. 2A. The transparent input component 43 is shown in a closed position in FIG. 4A. FIG. 4B shows the apparatus of FIG. 4A with the transparent input component 43 folded into an open position. In FIG. 4B a transparent keyboard on the transparent input component 43 has been made visible. Now a keyboard with different types of symbols 44 and 45 are shown. For example size and color of the symbols 44 and 45 may be different.

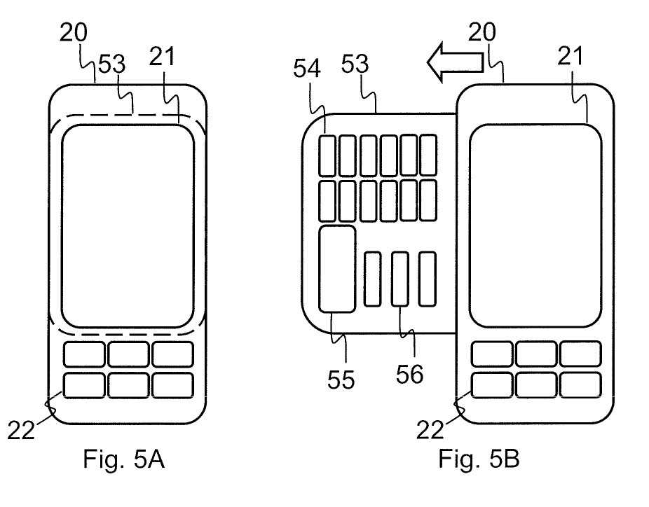

FIG. 5A shows an apparatus according to an example embodiment of the invention. The apparatus is similar to the one of FIG. 2A, except that now the apparatus comprises a transparent input component 53 instead of the transparent input component 23 of FIG. 2A. The transparent input component 53 is slidably connected to the body part 20. The transparent input component 53 is shown in a closed position in FIG. 5A. FIG. 5B shows the apparatus of FIG. 5A with the transparent input component 53 slid into an open position. In FIG. 5B a transparent keyboard on the transparent input component 53 is made visible. Also here different types of symbols 54, 55 and 56 are shown the same way as in FIG. 4B.

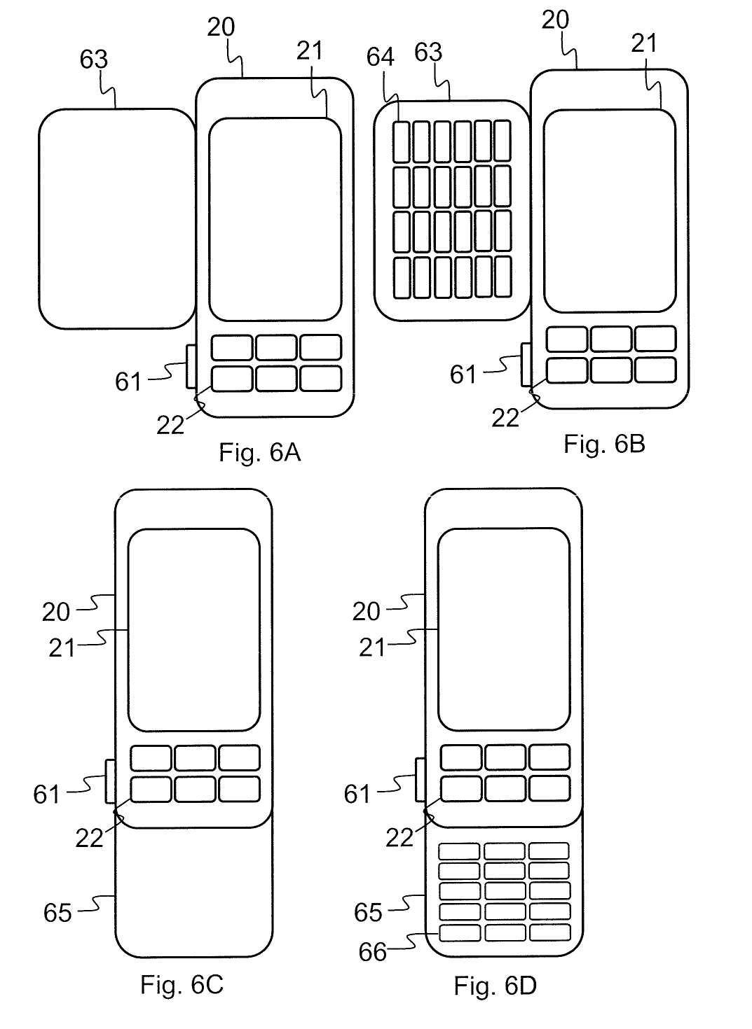

FIGS. 6A and 6B show an apparatus according to an example embodiment of the invention. The apparatus is similar to the one of FIGS. 2A and 2B, except that now the apparatus comprises a transparent input component 63 instead of the transparent input component 23 of FIGS. 2A and 2B. Further, the apparatus comprises a switch 61 and the apparatus is configured to make a transparent keyboard on the input component 63 visible or invisible responsive to the switch 61 being actuated. FIG. 6A shows the transparent keyboard in invisible setting and FIG. 6B shows the transparent keyboard 64 in visible setting.

FIGS. 6C and 6D show an apparatus according to an example embodiment of the invention. The apparatus is similar to the one of FIGS. 3A and 3B, except that now the apparatus comprises a transparent input component 65 instead of the transparent input component 33 of FIGS. 3A and 3B. Further, the apparatus comprises a switch 61 and the apparatus is configured to make a transparent keyboard on the input component 65 visible or invisible responsive to the switch 61 being actuated. FIG. 6C shows the transparent keyboard in invisible setting and FIG. 6D shows the transparent keyboard 66 in visible setting.

In an embodiment, the input components 63 and 65 in FIGS. 6A and 6C can operate as a track pad when the transparent keyboard on the input component is invisible.

As an alternative to actuating a switch or pushing a button to make the transparent keyboard visible, the transparent keyboard may be made visible automatically responsive to a specific position of the input component. For example, the transparent keyboard may be made visible responsive to the input component being moved into an open position.

In an example embodiment, a body part of an apparatus includes a source of light configured to provide illumination of the certain type and to selectively illuminate a transparent input component attached to the apparatus. The source of light may provide UV illumination. In an example embodiment, the source of light comprises one or more ultraviolet light emitting diodes. In an example embodiment, the source of light is configured to be controlled responsive to a position of the transparent input component in relation to the body part or responsive to a switch included in the apparatus being actuated.

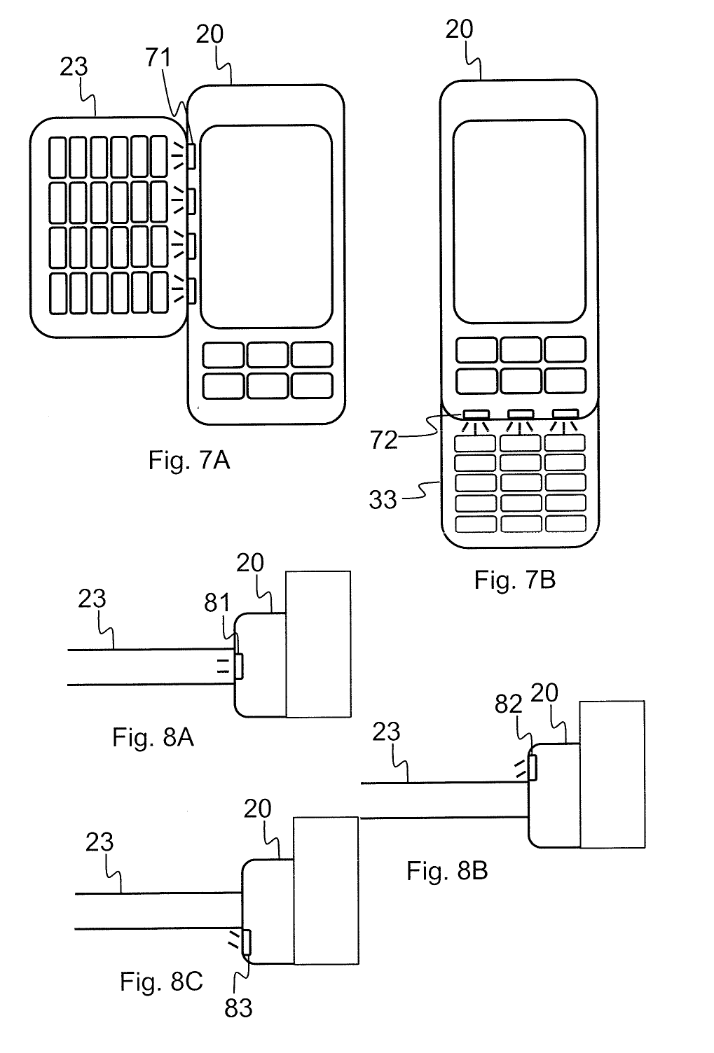

FIG. 7A shows an example illumination arrangement in the apparatus of FIGS. 2A and 2B. A set of small sized UV LEDs (light emitting diodes) 71 is included in the body part 20. The figure shows four LEDs, but any suitable number of LEDs can be used. For example 1, 2, 10, 20, or 50 LEDs can be used. The LEDs can be placed at the edge of a printed wiring board (PWB) inside the body part and suitable openings can be made in the side wall of the body part to allow the light of the LEDs to be guided to the input component 23. In this way wiring needed for turning on the LEDs 71 can be easily implemented and dynamical wiring is not needed for making the invisible symbols of the input component 23 visible.

In an example embodiment, at a suitable position of the input component 23, e.g. when the input component 23 is folded open, the LEDs 71 are able to illuminate the cover layer of the input component and the cover layer acts as a light guide guiding the light from the LEDs to the symbols in the input component and making the symbols visible. The LEDs can be controlled responsive to a specific position of the input component 23 or responsive to actuating a switch or pushing a button. The LEDs may be turned on or off automatically responsive to a specific position of the input component 23 or they may be turned on or off responsive to actuating a switch or pushing a button, for example.

FIG. 7B shows an example illumination arrangement in the apparatus of FIGS. 3A and 3B. In the same way as in FIG. 7A, now LEDs 72 provide illumination of the input component 33 and make the invisible symbols of the input component 33 visible.

The illumination arrangements of FIGS. 7A and 7B are shown in connection with apparatuses of FIGS. 2A-2B and 3A-3B for the sake of clarity. It is clear that also other apparatuses according to example embodiments of the invention may employ similar illumination arrangements.

FIGS. 8A-8C show side-views of example illumination arrangements. The shown illumination arrangements may be employed e.g. in apparatus of FIG. 7A or in an apparatus of some other embodiment. In FIG. 8A light of UV LEDs 81 inside the body part 20 is directed to the input component 23 from the side wall of the input component. In FIG. 8B light of UV LEDs 82 inside the body part 20 is directed to the input component 23 from above the input component. In FIG. 8C light of UV LEDs 83 inside the body part 20 is directed to the input component 23 from below the input component.

It should be noted that UV LEDs shown in FIGS. 7A-8C are only one example of suitable source of light. Also some other source of light can be used within the scope of the invention.

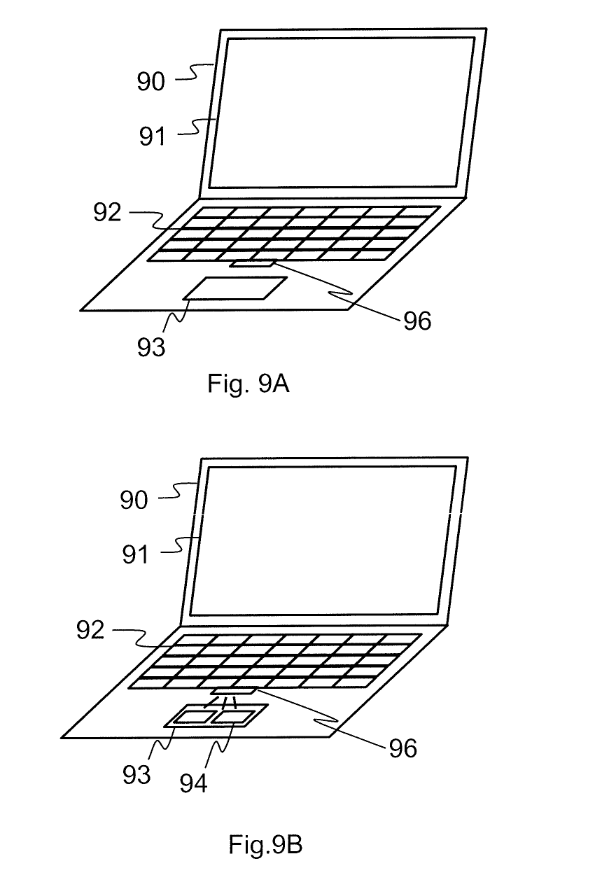

FIG. 9A shows an apparatus according to yet another example embodiment of the invention. The apparatus comprises a body part 90, a display 91, a keyboard 9, a track pad 93 and a source of light 96. The track pad comprises a transparent or invisible input component including symbols which are invisible in daylight conditions and become visible when illuminated with certain type of illumination. The symbols can be printed e.g. with UV ink. The source of light 96 is configured to selectively illuminate the track pad 93 and thereby make the symbols on the track pad visible. In this way a keyboard can be integrated in the track pad 93 and a dual-mode input component can be provided.

FIG. 9A shows the apparatus in normal mode, in which the source of light 96 is turned off and the symbols on the track pad are invisible. In this mode the track pad operates as a normal track pad. FIG. 9B shows the apparatus in an extra keyboard mode, in which the source of light 96 is turned on and the symbols 94 on the track pad 93 are visible. In this mode the track pad operates as an extra keyboard for user input. The extra keyboard on the track pad can be made visible and hidden again e.g. responsive to switching a switch or pushing a button.

Certain embodiments of the invention may provide following advantages:
The invisible or transparent ink can be used to produce a fully transparent component thereby improving user experience.
In various embodiments of the invention there is no need to take electrical signals to the input component e.g. through a hinge for enabling showing the symbols, i.e. it may be possible to reduce dynamically moving signal wires.
Separate illumination is not necessarily required in various embodiments of the invention for dark conditions as illumination is already used in various embodiments.
Various embodiments of the invention enable the use of multi-coloured UI symbols.
In addition to various other effects, the use of UV illumination (UV radiation) may help to sterilize the input device while in use and thereby work against bacteria.
Embodiments employing UV light can use UVA-type of radiation, which is harmless to human due to the long wavelength and low energy of the light. Therefore it is safe to use the UV light.

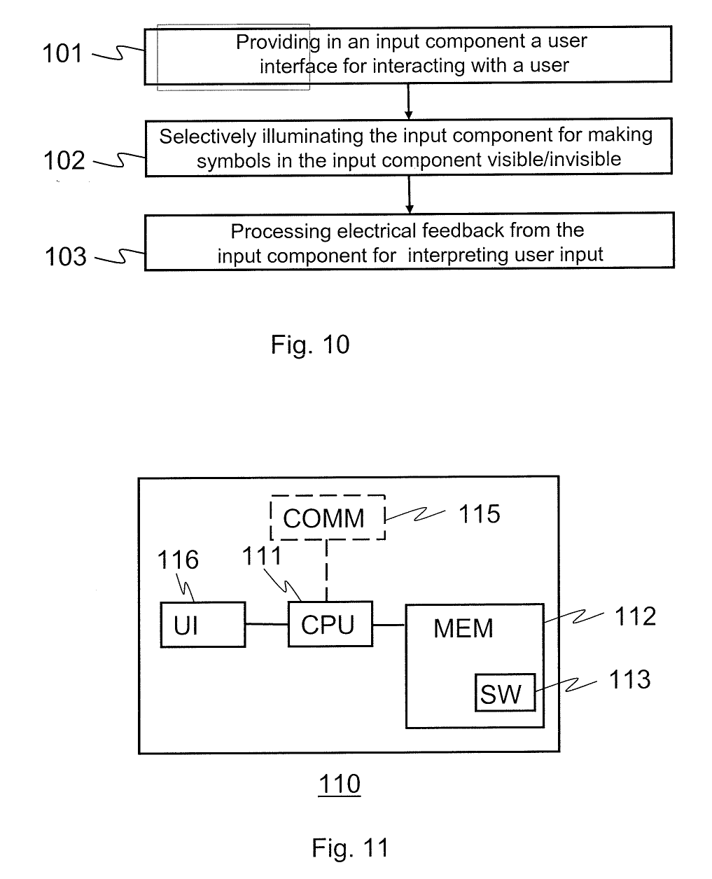

FIG. 10 shows a flow chart of an example method.

In phase 101, a user interface for interacting with a user of an apparatus is provided in an input component of the apparatus. The input component comprises symbols or graphics that become visible when illuminated with certain type of illumination. In phase 102, the input component is selectively illuminated to the symbols on the input component visible or invisible, i.e. for selectively showing the input symbols of the user interface for the user. In phase 103, electrical feedback from the input component is then processed in order to interpret user input.

The method of FIG. 10 can be implemented in software, hardware, application logic or a combination of software, hardware and/or application logic. The software, application logic and/or hardware may reside for example on any one of the apparatuses shown in FIGS. 2A-9B.

In an embodiment, there is provided a computer program or software configured to control an apparatus to perform at least the procedures of phases 101 and 103 of FIG. 10. A computer program is not necessarily needed for effecting the illumination phase, but the computer program can be used also for controlling the illumination.

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 11 below. The computer-readable medium may be a digital data storage such as a data disc or diskette, optical storage, magnetic storage, holographic storage, phase-change storage (PCM) or opto-magnetic storage. The computer-readable medium may be formed into a device without other substantial functions than storing memory or it may be formed as part of a device with other functions, including but not limited to a memory of a computer, a chip set, and a sub assembly of an electronic device.

FIG. 11 shows a block diagram of an example apparatus 110. The apparatus can be for example any one of the apparatuses shown in FIGS. 2A-9B.

The apparatus 110 comprises at least one memory 112 configured to store computer program code (or software) 113. The apparatus 110 further comprises at least one processor 111 for controlling the operation of the apparatus 110 using the computer program code 113, and a user interface 116. The user interface comprises an input component for user input. The input component comprises symbols or graphics that become visible when illuminated with certain type of illumination. Additionally the user interface may include at least one display and other keyboards or keypads. Further the apparatus may comprise a communication unit 115 for communicating with other entities or apparatuses (shown with dashed line). It is not mandatory to have the communication unit, though.

The at least one processor 111 may be a master control unit (MCU). Alternatively, the at least one processor 111 may be a microprocessor, a digital signal processor (DSP), an application specific integrated circuit (ASIC), a field programmable gate array, a microcontroller or a combination of such elements. FIG. 11 shows one processor 111, but the apparatus 110 may comprise a plurality of processors 111. The communication unit 115 may be, e.g., a radio interface module, such as a WLAN, Bluetooth, GSM/GPRS, CDMA, WCDMA, or LTE radio module. The communication unit 115 may be integrated into the apparatus 110 or into an adapter, card or the like that may be inserted into a suitable slot or port of the apparatus 110. The communication unit 115 may support one radio interface technology or a plurality of technologies. FIG. 5 shows one communication unit 115, but the apparatus 110 may comprise a plurality of communication units 115.

A skilled person appreciates that in addition to the elements shown in FIG. 11, the apparatus 110 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 110 may comprise a disposable or rechargeable battery (not shown) for powering the apparatus 110 when external power if external power supply is not available.

As to the operations of the embodiments of the invention, when the computer program code 113 is executed by the at least one processor 111, this causes the apparatus 110 to process electrical feedback from the input component of the user interface 116. The electrical feedback represents user input and thereby the computer program controls the processor 111 to process user input.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention. It is also noted that the above embodiments are used merely to explain selected aspects or steps that may be utilized in implementations of the present invention. Some features may be presented only with reference to certain example embodiments of the invention. It should be appreciated that corresponding features may apply to other embodiments as well.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

We claim:

1. An apparatus comprising:
a body part,
an input component coupled with the body part,
the input component having graphics, the graphics being invisible in daylight conditions and visible when exposed to a certain type of illumination, and
a source of light configured to provide illumination of the certain type and to selectively illuminate the input component.

2. The apparatus of claim 1, wherein the input component is transparent.

3. The apparatus of claim 1, wherein the input component is movably coupled with the body part.

4. The apparatus of claim 1, wherein the input component comprises a touch sensitive layer and a cover layer.

5. The apparatus of claim 4, wherein the cover layer is configured to act as a light guide guiding illumination to the graphics on the input component.

6. The apparatus of claim 4, wherein the graphics are printed on the touch sensitive layer.

7. The apparatus of claim 1, wherein the source of light is included in the body part.

8. The apparatus of claim 1, wherein the graphics are printed on the input component with transparent ultraviolet ink and the illumination is ultraviolet illumination.

9. The apparatus of claim 1, wherein the input component is foldably or slidably coupled with the body part.

10. The apparatus of claim 1, wherein the source of light is configured to be controlled responsive to a position of the input component in relation to the body part or responsive to a switch being actuated.

11. The apparatus of claim 1, wherein the input component is a track pad component.

12. The apparatus of claim 1, wherein the body part comprises a display.

13. The apparatus of claim 12, wherein the input component is transparent and covers the display at least partially when the input component is in a closed position in relation to the body part of the apparatus.

14. An input component comprising:
a touch sensitive layer,
a cover layer, and
graphics, the graphics being invisible in daylight conditions and visible when exposed to a certain type of illumination.

15. The input component of claim 14, wherein the cover layer is configured to act as a light guide guiding illumination to the graphics on the input component.

16. The input component of claim 14, wherein the graphics are printed on the touch sensitive layer.

17. A method comprising:
providing a user interface, the user interface comprising an input component and the input component comprising graphics that are invisible in daylight conditions and visible when exposed to a certain type of illumination, and
selectively illuminating the input component with illumination of the certain type.

18. The method of claim 17, further comprising: processing electrical feedback from the input component.

19. A computer program product comprising a computer readable storage medium having computer executable program code stored thereon which, when executed by at least one processor of an apparatus, the apparatus comprising a body part, an input component attached to the body part, and graphics on the input component, the graphics being invisible in daylight conditions and visible when exposed to a certain type of illumination, causes the apparatus to perform:
providing through the input component a user interface configured to interact with a user of the apparatus, and
processing electrical feedback from the input component.

20. The computer program product of claim 19, wherein the computer executable program code, when executed by at least one processor of the apparatus, further causes the apparatus to perform: selectively illuminating the input component with illumination of the certain type.
